(19) United States
(12) Patent Application Publication
(10) Pub. No.: US 2022/0198269 A1
(43) Pub. Date: Jun. 23, 2022

(54) BIG AUTOMATION CODE

(71) Applicant: Siemens Aktiengesellschaft, Munich (DE)

(72) Inventors: Arquimedes Martinez Canedo, Plainsboro, NJ (US); Palash Goyal, Los Angeles, CA (US); Jason Vandeventer, Charlotte, NC (US); Ling Shen, Cherry Hill, NJ (US)

(21) Appl. No.: 17/425,990

(22) PCT Filed: Feb. 5, 2019
(86) PCT No.: PCT/US2019/016583

§ 371 Date: Jul. 28, 2021

(51) Int. Cl. G06N 3/08; G06F 8/30; G06F 8/41

(52) U.S. Cl. CPC G06N 3/08; G06F 8/41; G06F 8/311

(57) ABSTRACT

A system and method to apply deep learning techniques to an automation engineering environment are provided. Big code files and automation coding files are retrieved by the system from public repositories and private sources, respectively. The big code files include examples general software structure examples to be utilized by the method and system to train advanced automation engineering software. The system represents the coding files in a common space as embedded graphs which a neural network of the system uses to learn patterns. Based on the learning, the system can predict patterns in the automation coding files. From the predicted patterns executable automation code may be created to augment the existing automation coding files.

### BACKGROUND

### 1. Field

The present disclosure is directed, in general, to industrial automation processes, and more specifically, to a method and system of applying artificial intelligence techniques, and specifically deep learning techniques, to improve an automation engineering environment.

### 2. Description of the Related Art

Industrial automation is currently driving innovation across all industries. Computer-based control processes are currently utilizing artificial intelligence techniques, and in particular, machine learning, to learn from data obtained from a variety of sources. Deep learning goes even further and may be considered a subset of machine learning. Instead of using a single layer or a few layers of neural networks, deep learning utilizes many layers of neural networks which enable the transformation of input data into more abstract and composite representations. Based on the machine learning, the control processes can make informed decisions without human intervention. In this way, automation control processes may be improved.

Currently, there are thousands of general purpose software projects that are open source and therefore publicly available in collaborative repositories on the internet such as GitHub. For example, GitHub currently hosts more the 38 million software repositories, accounting for billions of lines of code. These repositories with large amounts of publicly available software is referred to as ‘big code.’

However, unlike general purpose software, automation code is often proprietary and therefore is not readily nor publicly available. Additionally, the automation code may be in a different language as the code files in the ‘big code’. Without software code examples, i.e., ‘data to give the learning processes’, training deep neural networks and other artificial intelligence techniques to improve the automation engineering process is not possible.

### SUMMARY

Briefly described, embodiments of the present disclosure relate to a system and method to apply deep learning techniques to improve an automation engineering environment.

A first embodiment provides a computer implemented method to apply deep learning techniques to improve an automation engineering environment. The method includes the steps of retrieving by a processor big code coding files from a public repositories and automation coding files from a private source. The processor represents the big code coding files and automation coding files in a common space as embedded graphs. Next, a training phase commences as patterns from the embedded graphs are learned utilizing a neural network residing in the processor. Based on the learned patterns, patterns in the automation are predicted using a classifier on an embedding space of the embedding graphs. Executable automation code is created from the predicted patterns to augment the existing automation coding files.

A second embodiment of provides a system to apply deep learning techniques to improve an automation engineering environment. The system includes a plurality of big code coding files in a first software language retrieved from a public repository and a plurality of automation coding files in a second software language retrieved from a private source. The system includes a processor couple to receive the big code coding files and automation coding files and utilizes a neural network to identify coding structures regardless of the coding language. A numerical parameter indicative of the coding structure is generated in order to predict patterns in the automation coding files. From the predicted patterns, the processor creates executable automation code to augment the plurality of input automation coding files in the second software language.

### BRIEF DESCRIPTION OF THE DRAWINGS

FIG. 1 is a simplified pictorial representation of a system of predicting automation code from a canonical model which utilizes big code data and small automation code as input in accordance with an embodiment of the present disclosure,

FIG. 2 is a system component-data flow diagram in accordance with an embodiment of the present disclosure,

FIG. 3 is a flow chart for the method to apply deep learning techniques to improve an automation engineering environment in accordance with an embodiment of the present disclosure, and

FIG. 4 is a system architecture diagram in accordance with an embodiment of the present disclosure.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

Prior to a factory going online, in which automated industrial work processes will be utilized, automation code must be developed by human developers to run the work processes. Automation code is the code that runs the work processes in the factory. These work processes may include, for example, controlling robots, machines and conveyor belts, as well as controlling the lighting within the factory.

The development phase of software is typically described as the ‘engineering phase’ in which engineers and other developers compose the ‘code’, i.e., automation code, utilizing an integrated development environment (IDE) software. The IDE may be defined as an interface between the programmer and the actual running code. The IDE ultimately checks, compiles, and deploys the developed software into the actual running automation code.

The performance and efficiency of the automation software developers can be improved utilizing artificial intelligence techniques in the form of deep learning that is already coded and available as open source code in the big code repositories. These artificial intelligence techniques, in the form of deep learning, may be applied to the integrated software environment and can assist the software developer by making recommendations while he/she is composing the automation code.

The lack of data to train advanced automation engineering software functionality has traditionally been solved with rule-based systems. Rules generalize common cases and therefore eliminate the need for data for training. The problem with rule-based systems is that they do not scale well because rules must be explicitly written by domain-experts. Complex interdependencies between rules must be also modelled. Quickly, this approach becomes difficult to maintain due to a very large number of rules that must be maintained to cover all cases.

For example, a very common feature in IDEs is code completion. Whenever the user types a token, or string, in the editor, the IDE provides a list of suggestions of what the next token should be. Let the ‘sensor1’ variable be an object of type ‘Sensor’ that is typed by the user in the editor. The IDE has an internal rule that expands all the members of the ‘Sensor’ type and displays it to user alphabetically. Clearly, an alphabetic sort is not very useful in all cases. If the ‘sensor1’ is being used in a for loop, it would be more relevant to display iterable members first such as ‘sensor1.start’ or ‘sensor1.end’. If the IDE vendor wants to implement this feature, this task may require new rules to be created, where depending on context (e.g. for loops, declaration, etc.) a different process is executed. With large amounts of data, deep learning methods allow for learning these rules. Unfortunately, large amounts of automation code are not available. It is an objective of this disclosure to create a large amount of automation code utilizing examples in ‘big code.’

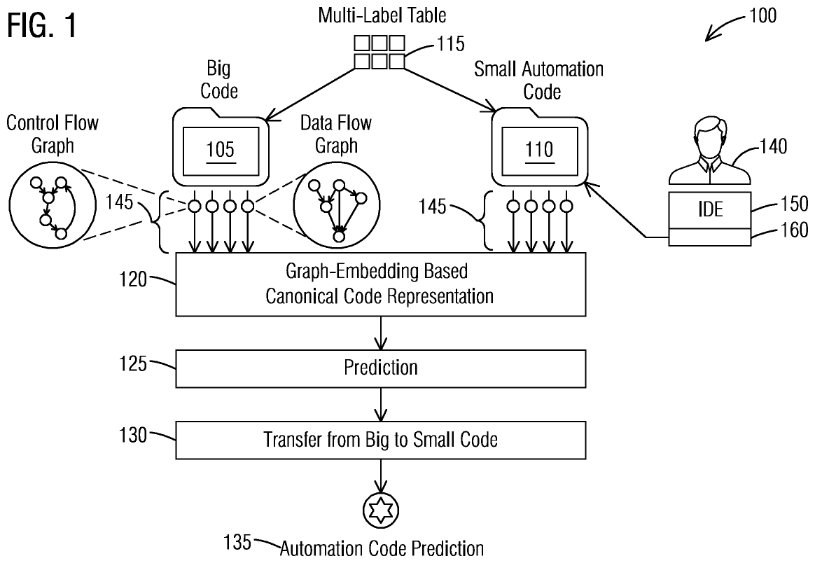

Referring now to FIG. 1, FIG. 1 depicts a high-level pictorial representation of a system 100 of predicting automation code from a canonical model which utilizes big code data and small automation code as inputs. Specifically, the model takes as inputs big code 105, small automation code 110, and a multi-label table 115. ‘Big code’, as described above, may contain multiple code files extracted from public software repositories such as Github. On the other hand, small automation code 110 may include proprietary company code not necessarily in the same language as the coding files in big code 105. The multi-label table 115 may be a set of possible predictions for autocompletion which may include a list of class functions such as start( ), end( ), iter( ), and a mapping in various languages. This mapping enables the system to produce graphs 145 depicting the code in a common space. The information from the big code is used to train a canonical model which may then be used to make predictions 125 in small automation code 110. These predictions may then be transferred 130 from the big code 105 to small automation code 110 and ultimately used to create 135 executable automation code.

In certain example embodiments, a user 140, such as a software developer, utilizing an IDE 150 provides input in the form of the small automation code. The user 140 will access the IDE 150 via a user device 160 such as a desktop or laptop computer, a tablet, a smartphone, or the like. Alternately, the small automation code may already exist stored on a server 510 or in an industrial controller 490.

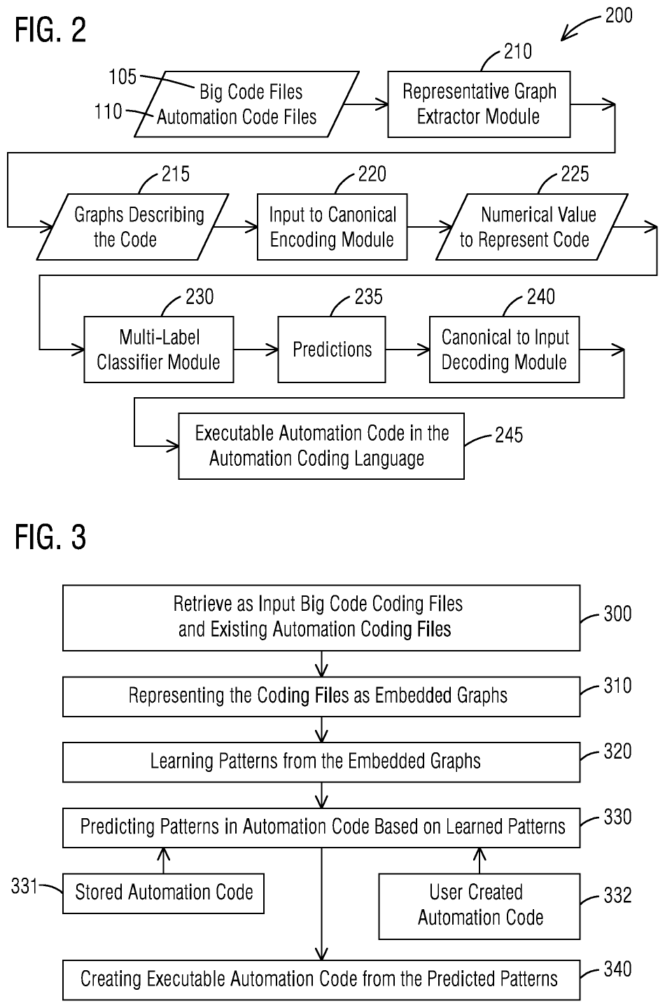

FIG. 2 is a system component/data flow diagram illustrating a system 200 and method to apply deep learning techniques to improve an automation engineering environment. The system 200 includes aspects that are stored and run within a computer utilizing at least one processor. The system 200 comprises a plurality of modules including a representative graph extractor module 210, an input to canonical encoding module 220, a multi-label classifier module 230, and a canonical to input decoding module 240.

In an embodiment, the representative graph extractor module 210 may be executed to receive as input the big code files 105 and the small automation code files 110. The representative graph extractor 210 takes in a coding file 105,110 as input and utilizing the multi-label table 115 outputs the coding file 105, 110 as a graph 215 describing the code. In this way, files coded in different languages may be represented in a common space. The different languages may include, for example, C, Python, and Java. Some examples of such graph representations 145 may be seen in FIG. 1 and include control flow graphs, data flow graphs, call graphs, and project structure graphs. These different types of graphs may illustrate different relevant views on the code. The graphs 145, 215 obtained may then be fed as inputs to an input to canonical decoding module 220.

The multi-label table 115 includes structure definitions so that the graph extractor module 210 has the ability to give labels to the structures found in the coding files 105, 110 regardless of the programming language of the code. For example, if the graph extractor module 210 encounters an expression in the code such as ‘a+b’ which includes the ‘+’ symbol, it may be labeled as an addition of two variables. As another example, when the code encounters a branching structure, in any language, it will be given the ‘branch’ label. In this way, similar structures in different languages may be classified in a common way.

In an embodiment, the input to canonical encoding module 220 receives the graphs 145, 215 as input. The encoding module 220 may utilize graph embedding techniques to learn patterns from the graphs. For example, a learning algorithm in the module 220 may assign a numerical representation 225 to a structure described by a particular graph type. The input to canonical encoding module 220 ensures that the coding files 105, 110 may be represented in a common space and can be compared. The numerical representation 225 may be in the form of a long vector so that a neural network on the computer may learn the code structure's latent representation by comparing the numerical values and sorting the vectors according to those that are numerically close to one another.

In order to learn representations of the input code, the input to canonical encoding module 220 looks at the graphs to see all the examples and generates a numerical vector 225 for each labelled structure. The vector may be n-dimensional where n is configurable during training by the user 140. For example, the size of the vector may be tweaked during training until the desired results are obtained. Each dimension of the vector may include a floating point numerical value 225. The structures with the same labels would be assigned numerical values that are close to one another. Thus, the input to canonical encoding module 220 maps a structure into a vector representation through graph embeddings. The encoding module 220 may then sort the numerical values so that those that are close may represent the same or similar labels.

In an embodiment, a multi-label classifier module 230 may then utilize the embeddings of the graphs 145, 215 generated from the coding files 105, 110 to predict an output label from the multi-label table 115. An example of a multi-label classifier used by this classifier module 230 is one-vs-rest logistic regression. Here, the learned vector representation of the code graphs 145, 215 is the input and the list of labels in the multi-label table 115 is the output. The module 230 learns dependence between embedding space and the output labels.

Lastly, in an embodiment, a canonical to input decoding module 240 utilizes the generated predictions to create executable automation code 245 in a particular software language. The particular software language may be the automation language found in the input automation coding files. The automation code augments the existing plurality of automation coding files.

In an embodiment, after the sorting of the numerical values, a validation step may proceed. A plurality of ‘test cases’ in the form of graphs may be utilized by the input to canonical module 220 software to validate that the learned patterns are labelled and sorted to a desired level.

In an embodiment, a user 140 provides input in the form of automation code 110 utilizing an integrated development environment 150. The system utilizes the learned patterns to predict the user's next code input to the automation code. These predicted patterns may then be output, on a display 160, to the user as suggestions. Then, for example, the user 140 may be prompted to accept or decline the suggestions for incorporation into the creation of the automation code. Alternately, a user may not be present such that the system may process a database of existing automation coding files 110 as well as the big code coding files 105 to create more automation code.

Referring now to FIG. 3, a flow chart depicting the method to apply deep learning techniques to improve an automation engineering environment is illustrated. A processor first retrieves 300, as input, big code coding files 105 from a public repository and existing automation coding files 110 from a private source. Next, the processor represents 310 the input coding files 105, 110 in a common space as graphs 145, 215. The processor uses a neural network to learn 320 patterns from the graphs Utilizing the learned patterns, the neural network may then predict 330 patterns in automation code. A user 140 may input the automation code 332 or it may be provided from a database 331. Lastly, the processor creates 340 executable automation code from the predicted patterns to augment the existing automation coding files.

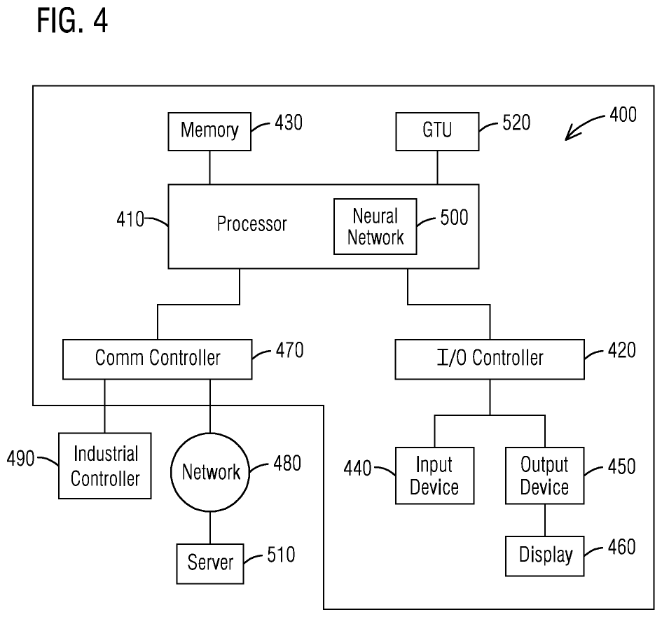

As is well understood, the software aspects of the present invention could be stored on virtually any computer readable medium including a local disk drive system, a remote server, internet, or cloud-based storage location. In addition, aspects could be stored on portable devices or memory devices as may be required. FIG. 4 illustrates the computer architecture of the presently described system. The computer 400 generally includes an input/output device that allows for access to the software regardless of where it is stored, one or more processors 410, memory devices 430, user input devices 440, and output devices 450 such as a display 460, printers, and the like.

The processor 410 could include a standard micro-processor or could include artificial intelligence accelerators or processors that are specifically designed to perform artificial intelligence applications such as artificial neural networks, machine vision, and machine learning or deep learning. Typical applications include algorithms for robotics, internet of things, and other data-intensive or sensor-driven tasks. Often AI accelerators are multi-core designs and generally focus on low-precision arithmetic, novel dataflow architectures, or in-memory computing capability. In still other applications, the processor may include a graphics processing unit (GPU) 520 designed for the manipulation of images and the calculation of local image properties. The mathematical basis of neural networks and image manipulation are similar, leading GPUs to become increasingly used for machine learning tasks. Of course, other processors or arrangements could be employed if desired. Other options include but are not limited to field-programmable gate arrays (FPGA), application-specific integrated circuits (ASIC), and the like.

The computer 400 also includes a communication controller 470 that may allow for communication between other computers or computer networks 480, as well as for communication with other devices such as machine tools, work stations, actuators, industrial controllers 490, sensors, and the like.

In summary, the computer 400 illustrated in FIG. 4 includes a neural network model 500 capable of deep learning that is used to create automation code based on learning from graphs derived from big code coding files and stored automation coding files. The neural network model 500 is trained using these graphs that depict code from a multitude of languages in a common space. Utilizing the training, the neural network model 500 has the ability to map examples from big code coding files 105 into the small automation code 110.

This disclosure addresses the lack of data to train advanced automation engineering software. The disclosed method as well as the corresponding system uniquely creates a canonical code representation utilizing graph embedding techniques. Ultimately, examples from big code are mapped to small automation code creating executable automation code. Thus, the system and method described herein produce the data need to train the advance automation engineering software without specific pre-programming of the computer.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A computer implemented method to apply deep learning techniques to improve an automation engineering environment, comprising:
retrieving 300, by a processor 410, big code coding files 105 from a public repository;
retrieving 300, by the processor, automation coding files 110 from a private source;
representing 310, by the processor, the big code coding files 105 and the automation coding files 110 in a common space as embedded graphs 145, 215;
learning patterns 320 from the embedded graphs 145, 215 utilizing a neural network 500 residing in the processor 410;
predicting 330 patterns in the automation coding files 110 based on the learned patterns using a classifier on an embedding space of the embedded graphs; and
creating 340 executable automation code from the predicted patterns to augment the existing automation coding files.

2. The method as claimed in claim 1, further comprising:
providing a multi-label table 115 including a list of class functions and a mapping of the class functions to a plurality of coding languages;
utilizing the mapping to label structures in the retrieved big code coding files 105 and the existing automation coding files 110 in order to represent the coding files 105, 110 in the common space as embedded graphs 145, 215.

3. The method as claimed in claim 2, wherein the learning includes assigning a numerical representation 225 to each labeled structure, wherein the numerical representation 225 is at least partially defined by the labeled structure.

4. The method as claimed in claim 3, wherein the numerical representation is an n-dimensional vector.

5. The method as claimed in claim 3, wherein the learning 320 includes utilizing the numerical representations of each labeled structure to find similar patterns, wherein the similar patterns are marked as including the same structure.

6. The method as claimed in claim 1, wherein the big code coding files 105 and the automation coding files 110 are in different coding languages.

7. The method as claimed in claim 1, wherein the embedded graphs 145, 215 are selected from the group consisting of control flow graphs, data flow graphs, call graphs, and project structure graphs.

8. The method as claimed in claim 5, further comprising comparing the learned patterns to a plurality of test embedded graphs to validate that the learned patterns are labeled and sorted to a desired level.

9. The method as claimed in claim 1, wherein the automation coding files 110 are produced by a user 140 in an integrated development environment 150 on a computer.

10. The method as claimed in claim 1, wherein the automation coding files 110 are retrieved from a database.

11. The method as claimed in claim 1, wherein the classifier is one-vs-rest logistic regression.

12. A system to apply deep learning techniques to improve an automation engineering environment, comprising:
a plurality of big code coding files 105, in a first software language, retrieved from a public repository;
a plurality of automation coding files 110, in a second software language, retrieved from a private source;
a processor 410 coupled to receive as input the plurality of big code coding files 105 and the plurality of automation coding files 110, and utilizing a neural network 500 identifies, coding structures regardless of the coding language and generates a numerical parameter indictive of the coding structure in order to predict patterns in the automation coding files 110,
wherein the processor 410 creates executable automation code from the predicted patterns to augment the plurality of input automation coding files in the second software language.

13. The system as claimed in claim 12, further comprising:
a multi-label table 115 including a list of class functions and a mapping of the class functions to a plurality of coding languages, wherein the mapping is utilized to label coding structures in the plurality of big code coding files 105 and automation coding files 110 in order to represent the coding files 105, 110 as a plurality of representative graphs 145, 215.

14. The system as claimed in claim 12, wherein the first software language and the second software language are different coding languages.

15. The system as claimed in claim 12, wherein the numerical parameter is an n-dimensional vector.

16. The system as claimed in claim 12, wherein the automation coding files are produced by a user 140 in an integrated development environment 150 on a computer 400 comprising the processor 410.

17. The system as claimed in claim 12, wherein the neural network 500 comprises a classifier taking the numerical parameter indicative of the coding structure and outputs a prediction in the form of a labeled structure.

18. The system as claimed in claim 17, wherein the prediction is accomplished utilizing the classifier on an embedding space of the representative graphs.

19. The system as claimed in claim 18, wherein the classifier is a one-vs-rest logistic regression classifier.
